(19) United States
(12) Patent Application Publication
(10) Pub. No.: US 2015/0078811 A1
(43) Pub. Date: Mar. 19, 2015

(54) MODULAR POWER TOOL

(71) Applicants: Benjamin Luke VAN DER LINDE, Heatherton (AU); David Leigh Scrimshaw, Heatherton (AU); Paul Francis Connor, Heatherton (AU); Paul Miller, Heatherton (AU); Ben Eyers, Heatherton (AU); Sion Netzler, Heatherton (AU); Lucas Lastman, Heatherton (AU)

(72) Inventors: Benjamin Luke VAN DER LINDE, Heatherton (AU); David Leigh Scrimshaw, Heatherton (AU); Paul Francis Connor, Heatherton (AU); Paul Miller, Heatherton (AU); Ben Eyers, Heatherton (AU); Sion Netzler, Heatherton (AU); Lucas Lastman, Heatherton (AU)

(73) Assignee: DEMAIN INTERNATIONAL PTY LTD., Heatherton (AU)

(21) Appl. No.: 14/491,481

(22) Filed: Sep. 19, 2014

Related U.S. Application Data
(63) Continuation of application No. 13/594,542, filed on Aug. 24, 2012, now abandoned.
Application No. 13/594,542 is a continuation of application No. PCT/AU2011/000209, filed on Feb. 25, 2011.

(30) Foreign Application Priority Data
Feb. 25, 2010 (AU) 2010900807
Feb. 25, 2010 (AU) 2010900808
Feb. 25, 2010 (AU) 2010900809
Feb. 26, 2010 (AU) 2010900831
Nov. 29, 2010 (AU) 2010905259

(51) Int. Cl. H01R 13/72; B25F 5/02

(52) U.S. Cl. CPC H01R 13/72; B25F 5/02
USPC 403/322.1

(57) ABSTRACT

A connection arrangement for releasably connecting an electrical device and a power control module, the power control module including a device for controlling the supply of electrical power to the functional component. The connection arrangement includes a first connecting portion associated with the electrical device or the power control module and configured to engage with a second connecting portion associated with the other one of the device and module. The first connecting portion including a first locking member and the second connecting portion including a second locking member, wherein when the first and second connection portions are engaged the first and second locking members are movable relative to each other between an unlocked position in which the first and second connection portions are separable and a locked position in which the first and second connection portions are locked together. Preferably, the electrical device is a power tool module.

### CROSS REFERENCE TO RELATED APPLICATIONS

This is a Continuation of application Ser. No. 13/594,542 filed Aug. 24, 2012, which is a Continuation of International Application No. PCT/AU2011/000209 filed Feb. 25, 2011, claiming priority based on Australian Patent Application No. 2010905259 filed Nov. 29, 2010, Australian Patent Application No. 2010900831 filed Feb. 26, 2010, Australian Patent Application No. 2010900808 filed Feb. 25, 2010, Australian Patent Application No. 2010900807 filed Feb. 25, 2010, Australian Patent Application No. 2010900809 filed Feb. 25, 2010, the disclosures of which are incorporated herein in their entirety by reference.

### FIELD OF THE INVENTION

The present invention relates to the field of electro-mechanical devices such as domestic appliances. In particular, the present invention relates to the field of handheld power tools and to a modular handheld power tool arrangement wherein a power tool handle and switch assembly is capable of releasable attachment to, and for controlling power input to, any one of a number of different modular power tool devices. However, it is to be appreciated that the present invention may have broader application for electrically powered appliances other than handheld power tools.

### BACKGROUND OF THE INVENTIONS

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

There are a wide variety of handheld power tools available for performing a variety of different functions. For example, there are drills for drilling, power drivers for driving screws, power saws for sawing work pieces, power grinders for grinding material from work pieces and a variety of other power tools for performing various other work. In order for a consumer to have a range of tools for performing any one or more required jobs it is necessary for the consumer to purchase a variety of power tools. Purchasing a wide variety of power tools can involve significant expense because each tool may include a variety of components including an electric motor, a switch, a handle assembly, a power cable or battery for supplying power to the tool that must be sourced by the manufacturer, assembled, packaged and transported.

In particular, tradesmen often own numerous handheld devices such as power drills, AC high speed drills, hammer drills, angle grinders, circular saw, jigsaws, sanders and so forth which may be connected to a power source or battery operated. Similarly, as the cost of power tools has diminished individuals in a domestic environment often possess a wide variety of power tools for DIY projects or hobbies.

In order to overcome the inconvenience and physical limitation of having a power cord attached to a power tool, cordless power tools adapted to receive non-rechargeable or rechargeable batteries were developed. Non-rechargeable batteries were typically loaded into a recess in the power tool handle and replaced when they were flat. Due to their need to be regularly replaced, some power tools have rechargeable batteries that are removably located in the power tool, or alternatively, the batteries can be plugged into a recharger while located in the handle.

Design of power tools (both those operating from a power source and those that are battery operated) has further progressed to include the use of a single handle that can be removably connected to a range of attachments for different applications. For example a single controller could be attached to a drill body, sander body, jigsaw body, grinder body and so forth. This modularity, particularly the ability to remove a handle from a power tool reduces the overall size of each unit, allowing more units to be stored in a given volume of space such as a shipping container (saving freight costs), or a retail shelf (allowing retailers to maximise stock and improve return on shelf or floor space cost) and simplifying inventory and reducing the amount of storage needed by users. Given that many people now live in apartments or town houses, the ability to more efficiently store tools in a small space in the home environment can be very appealing to home handymen and hobbyists.

For example U.S. Pat. No. 6,286,611 (Black & Decker Inc) discloses a power tool including a motor mounted in a handle, the handle being adapted for connection to any one of a plurality of tool head attachments to form a tool dedicated for a particular job. Typically each tool head attachment has a drive mechanism that engages a spindle cog. The spindle has a male cog attachment for mesh engagement with a female cog of a drive mechanism on the power tool head. The tool head is kept in connection with the drive mechanism by a locking mechanism.

U.S. Pat. No. 6,796,389 (Snap-on Incorporated) teaches the use of a handle grip which slides over a handle of a tool body where it is retained by flanges that resiliently clip into grooves in the handle.

U.S. Pat. No. 6,181,032 (Black & Decker Inc) relates to an interface for releasably connecting a power control module or battery pack to an electrical tool. A power control switch is located on the electrical tool and is actuated by a manual trigger on the power control module/handle. The interface is formed by sliding connection between the power control module and electrical tool via a pair of dovetail connections with interlocking flanges. The trigger operates a linkage that reaches through the interface plane into the tool to operate a switch located within the tool.

U.S. Pat. No. 7,414,211 (C Enterprise HK Ltd) relates to a cordless power tool having a handle that can house multiple rechargeable cylindrical batteries. Complementary female and male connectors provided respectively on the power handle and on the electrical tool permit sliding engagement and disengagement, the male connector having electrical contact means exposed thereon for engagement with the electrical contacts on the power handle.

U.S. Pat. No. 6,443,675 (Roto Zip Tool Corp) relates to a hand held power tool having a motor housing and detachable handle bearing a manually operable trigger switch. The trigger switch is coupled to a motor controller within the motor housing without use of a direct mechanical connection so as not to interfere with the easy and quick attachment and detachment of the handle to and from the housing. Fixed housing mounting structures such as housing apertures are formed in the tool housing and positioned therein for receiving extending tabs (preferably hook shaped to hook into the apertures) and a rotatable rod which extend from the ends of the handle. The end of the rod preferably includes one or more distal radially extending portions that fits through slots in the tool housing and can be oriented to resist removal of the handle from the power tool.

US patent application 2006/003776 (Gass & D'Ascenzo) relates to an electrically powered hand drill/driver having a housing containing a motor and a handle and a power control module to deliver power to the motor. The housing and power control module are connected by a ridge that fits in a slot, held in place by a locking member.

One of the problems associated with modular power tools of the prior art, or more particularly their connections, is that they permit a degree of movement between the parts. A user typically notices a ‘wobble’ between the parts. Any instability in the connection of an electro-mechanical device tends to cause concern in the mind of a user, particularly concerns relating to electric shock. This is particularly so with respect to alternating current (AC) devices which are of higher energy than direct current (DC) devices. Furthermore, any movement at electrical contacts between the parts can cause arcing, accelerated wear and concomitant decrease in efficiency.

Accordingly, it would be desirable to be able to provide a variety of power tools at less cost to the consumer. It would also be desirable to provide an improved connection between parts of an electro-mechanical device.

### SUMMARY OF THE INVENTION

In a first aspect of embodiments described herein there is provided a connection for releasably connecting two parts of an electro-mechanical device, the connection including;
(i) a first connecting portion associated with a first part, and a second connecting portion associated with a second part, such that engagement of the first and second connecting portions imparts bias between the two parts, and
(ii) a retention means suitable for maintaining the bias between the two parts.

Accordingly, the present invention provides, in a second aspect, a connection arrangement for releasably connecting an electrical device and a power control module, the electrical device including an electrically powered functional component, the power control module including a device for controlling the supply of electrical power to the functional component when the electrical device and the power control module are connected, the connection arrangement including:
a first connecting portion associated with one of the electrical device or the power control module and configured to interengage with a second connecting portion associated with the other one of the electrical device and the power control module;
the first connecting portion including a first locking member and the second connecting portion including a second locking member, wherein when the first and second connection portions are engaged the first and second locking members are movable relative to each other between an unlocked position in which the first and second connection portions are separable and a locked position in which the first and second connection portions are locked together.

In embodiments of the invention, in the locked position the first and second connection portions are compressed together.

In another embodiment, in the locked position the first and second locking members engage each other in an interference fit.

In yet another embodiment, the first connecting portion including a first connection member and the first locking member, the second connecting portion including a second connection member and the second locking member, the first and second connection members are connectable together such that the first and second locking members are movable relative to each other between a separated position and a locking position, wherein in the locking position the first and second locking members are movable relative to each other between the locked position and the unlocked position.

In a further embodiment, the first and second connection members are pivotally connectable so that when the first and second connection members are connected together the first and second locking members pivot relative to each other in an arc between separated and locking positions. Preferably, the first and second connection members are of complementary shape.

In yet a further embodiment, the first connection member and the first locking member are spaced apart in a direction along a first connecting axis, the second connection member and the second locking member are spaced apart in a direction along a second connecting axis, wherein connecting the first and second connecting portions involves orienting the first connecting portion relative to the second connecting portion so that the first connecting axis and the second connecting axis converge and moving the first and second connection members into engagement. Thus, for example, the first connection member/first locking member and the second connection member/second locking member form a hinge having a longitudinal axis substantially parallel to the direction of force applied to the device during use.

In preferred embodiments, the first and second connection members include a slot and ridge that is receivable within the slot to thereby connect the first and second connection members together.

In further preferred embodiments, the first and second locking members include an anchor and a movable catch, wherein when the first and second locking members are in the locking position the catch is movable between an unlocked position in which the anchor is free to move relative to the catch and a locked position in which the anchor is engaged by the catch in an interference fit.

In an embodiment of the invention, the catch includes a sloping surface that contacts with a surface adjacent to the anchor such that upon movement of the first and second locking members relative to each other between the separated position and the locking position the sloping surface slides against the surface adjacent to the anchor and is actuated between the locked and the unlocked positions.

In a preferred embodiment, the catch is at least partially actuated between the unlocked and the locked positions by a biasing mechanism.

In another preferred embodiment, the catch is at least partially manually actuated between the unlocked and the locked positions.

In further preferred embodiments, the first connecting portion includes a first electrical contact and the second connecting portion includes a second electrical contact, the first and second electrical contacts being configured to come into physical contact when the first connecting portion mates with the second connecting portion.

In another embodiment, the power control module includes a housing and the electrical contact of the connecting portion of the power control module is recessed within the housing for preventing user contact with the recessed electrical contact.

In yet another embodiment, the power control module includes a handle and a switch assembly for controlling the supply of electrical power to the functional component when the electrical device and the power control module are connected.

In still yet another embodiment, the power control module includes an electrical cable for connection to an alternating current power supply and facilitating the passage of electrical power to the power control module.

In another embodiment, the power control module includes a rechargeable power storage device.

In a preferred embodiment, the electrical device includes a power tool module.

In another aspect, the invention provides a power control module for releasable connection to an electrical device including an electrically powered functional component, the power control module including a device for controlling the supply of electrical power to the functional component when the electrical device and the power control module are connected, the power control module including:
a housing including a connecting portion including a locking member,
the connecting portion being configured to interengage with the electrical device and when engaged the locking member includes a locked condition and an unlocked condition, wherein in the unlocked condition the power control module is separable from the electrical device and in the locked condition the connecting portion of the power control module is compressed together with the electrical device.

In embodiments of the invention, the connecting portion includes a connection member and the locking member, the connection member being configured for connection together with the electrical device and when connected the locking member is movable relative to the electrical device between a separated position and a locking position to thereby mate the connecting portion to the electrical device.

In an embodiment, the connection member includes a slot for receiving a ridge of the electrical device and to enable the connecting portion to pivot about the slot and the ridge between the separated position and the locking position. In a particularly preferred embodiment the slot and ridge are of complementary shape.

In another embodiment, the locking member includes a movable catch configured to interact with an anchor of the electrical device wherein in the locking position the catch is movable between an unlocked position in which the catch is free to move relative to the anchor and a locked position in which the anchor is engaged by the catch in an interference fit.

In yet another embodiment, the catch is at least partially actuated between the unlocked and the locked positions by a biasing mechanism.

In still yet another embodiment, the catch is at least partially manually actuated between the unlocked and the locked positions.

In an embodiment, the connecting portion includes an electrical contact recessed within the housing and configured to come into physical contact with a protruding electrical contact of the electrical device when the connecting portion mates with the electrical device.

In another embodiment, the power control module includes a handle and a switch assembly for controlling the supply of electrical power to the functional component when the electrical device and the power control module are connected.

In yet another embodiment, the power control module includes an electrical cable for connection to an alternating current power supply and facilitating the passage of electrical power to the power control module.

In another aspect, the invention provides an electrical device including an electrically powered functional component for releasable connection to a power control module, the power control module including a device for controlling the supply of electrical power to the functional component when the electrical device and the power control module are connected, the electrical device including:
a housing including a connecting portion including a locking member,
the connecting portion being configured to interengage with the power control module and when engaged the locking member includes a locked condition and an unlocked condition, wherein in the unlocked condition the electrical device is separable from the power control module and in the locked condition the connecting portion of the electrical device is compressed together with the power control module.

In one embodiment, the connecting portion includes a connection member and the locking member, the connection member being configured for connection together with the electrical device and when connected the locking member is movable relative to the electrical device between a separated position and a locking position to thereby mate the connecting portion to the electrical device.

In one embodiment, the connection member includes a ridge for insertion into a slot of the power control module and to enable the connecting portion to pivot about the slot and the ridge between the separated position and the locking position.

In another embodiment, the locking member includes an anchor configured to interact with a movable catch of the power control module wherein in the locking position the catch is movable between an unlocked position in which the catch is free to move relative to the anchor and a locked position in which the anchor is held by the catch.

In still yet another embodiment, the connecting portion includes an electrical contact protruding from the housing and configured to come into physical contact with a recessed electrical contact of the power control module when the connecting portion mates with the power control module.

In a further embodiment, there is provided a method of connecting two parts of a power tool according to the present invention, including the steps of;
(i) engaging the first connecting portion with the second connecting portion such that bias is imparted between the two parts, and
(ii) simultaneously or subsequently, applying the retention means to maintain bias between the two parts.

In one embodiment, the electrical device includes a power tool module.

### BRIEF DESCRIPTION OF THE DRAWINGS

The present invention will now be described in more detail with reference to the following Figures. The following Figures represent embodiments of the invention in the form of a power control module and a modular power tool, in the form of modular power drill, and for the sake of convenience the present invention will be described below in detail with reference to the modular power drill embodiment. It is to be appreciated, however, that the present invention may be suitable for use with other modular electrical devices including other forms of power tools such as handheld power saws, power screwdrivers, power percussion/hammer drills as well other electrical devices such as a light emitting device, radio, or a digital music player to name but a few.

FIG. 1 illustrates a perspective view of a modular electrical device and power control module arrangement including an electrical device in the form of a modular power drill and a power control module including a handle and switch assembly wherein the power tool and the power control module are in the assembled condition.

FIG. 2 illustrates a perspective view of the assembly of FIG. 1 wherein the power tool and the power control module are in the partially assembled condition.

FIG. 3 illustrates a front view of the assembly of FIG. 1 wherein the power drill and the power control module are in the partially assembled condition.

FIG. 4 illustrates a front view of the assembly of FIG. 1 wherein the power drill and the power control module are in the assembled condition.

FIG. 5 illustrates a perspective view of the power control module of the assembly of FIG. 1.

FIG. 6 illustrates a perspective view of the power drill of the assembly of FIG. 1.

FIG. 7 illustrates a side view of another embodiment of the modular electrical device and power control module of the invention wherein the power drill and the power control module are in the assembled condition.

FIG. 8 illustrates a rear view of the assembly of FIG. 7 wherein the power drill and the power control module are in the assembled condition.

FIG. 9 illustrates a side view of the assembly of FIG. 7 wherein the power drill and the power control module are in a partially assembled condition.

FIG. 10 illustrates a rear view of the assembly of FIG. 7 wherein the power drill and the power control module are in the partially assembled condition.

FIG. 11 illustrates a side view of the assembly of FIG. 7 wherein the power drill and the power control module are in a separated condition.

FIG. 12 illustrates a rear view of the assembly of FIG. 7 wherein the power drill and the power control module are in the separated condition.

FIG. 13 illustrates a perspective view of the assembly of FIG. 7 wherein the power drill and the power control module are in the separated condition.

FIG. 14 illustrates a perspective view of the assembly of FIG. 7 wherein the power drill and the power control module are in the separated condition.

FIG. 15 illustrates a perspective view of the assembly of FIG. 7 wherein the power drill and the power control module are in the partially assembled condition and part of the housing of the power drill and the power control module are hidden.

FIG. 16 illustrates a perspective view of the assembly of FIG. 7 wherein the power drill and the power control module are in the assembled condition and part of the housing of the power drill and the power control module are hidden.

FIG. 17 illustrates a perspective view of a power control module arrangement in accordance with another embodiment of the invention with part of the housing of the module removed.

FIG. 18 illustrates a perspective view of an electrical device operable to be coupled to the power control module arrangement of FIG. 17, the electrical device being in the form of a modular power drill.

FIG. 19 illustrates another perspective view of the electrical device of FIG. 18.

### DETAILED DESCRIPTION

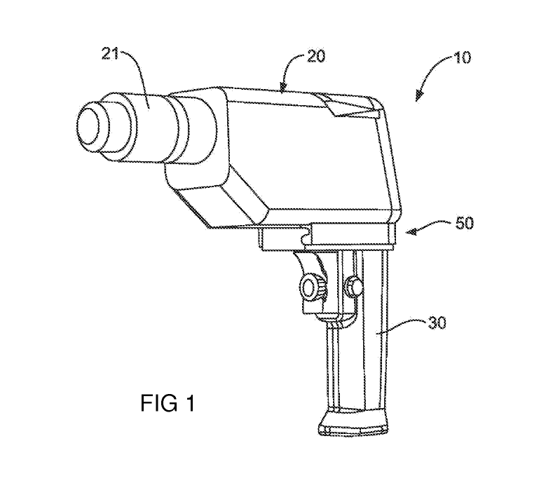

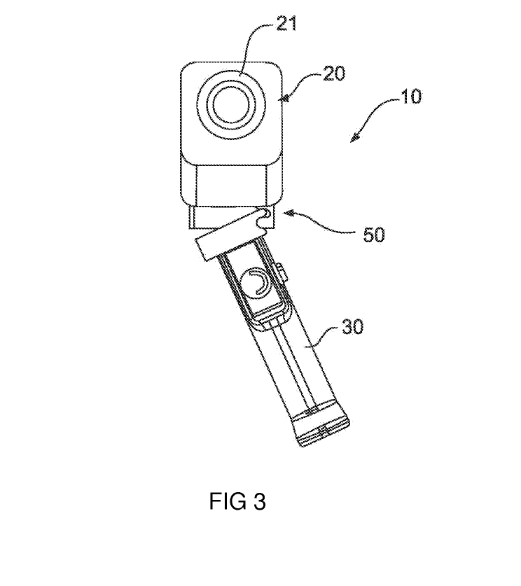

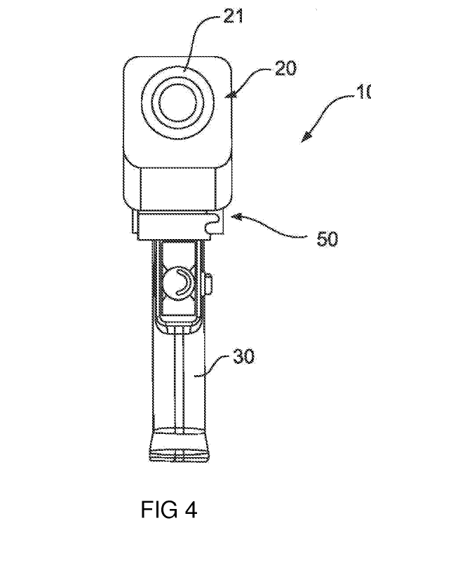

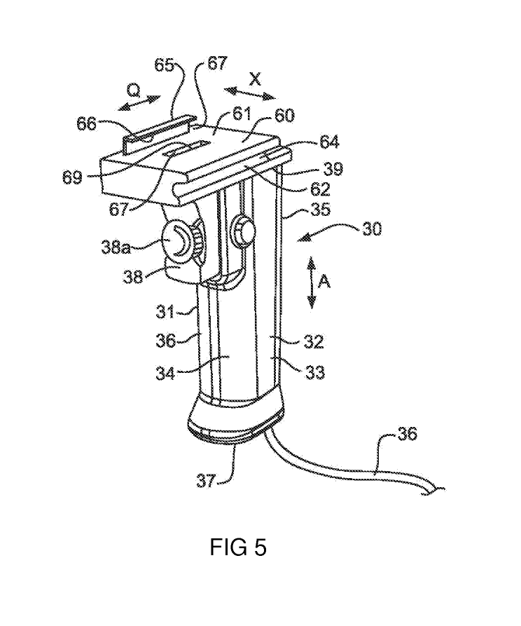

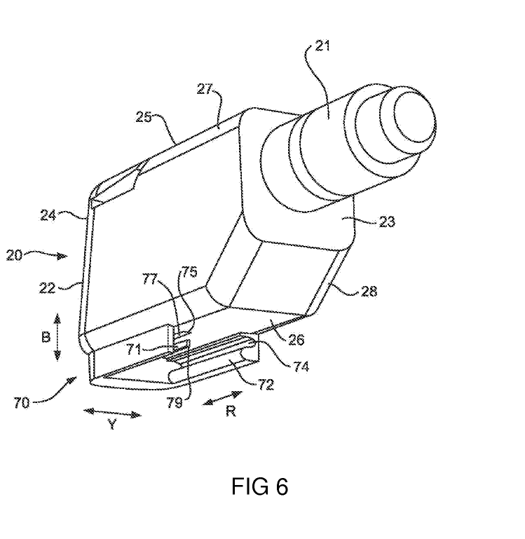

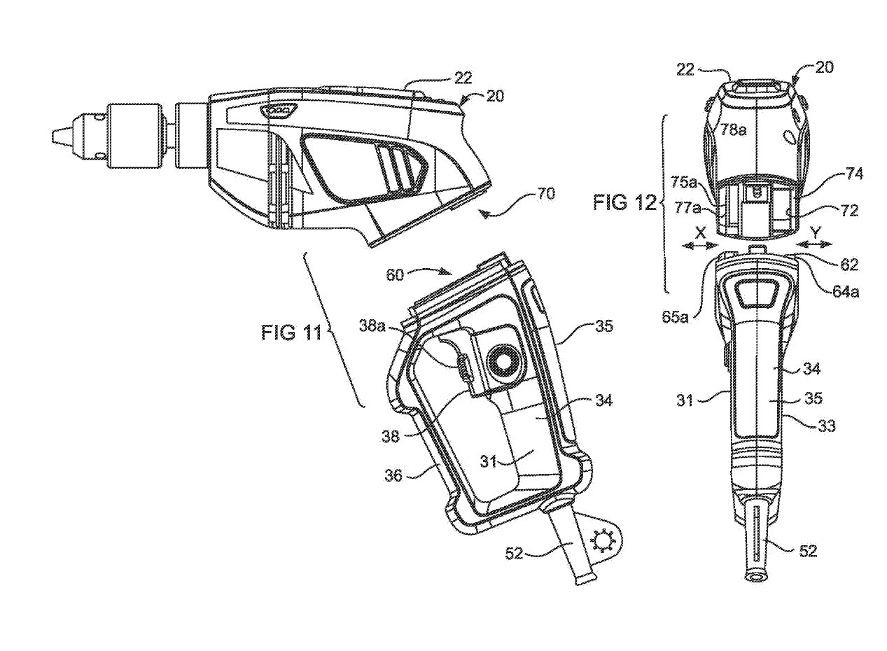

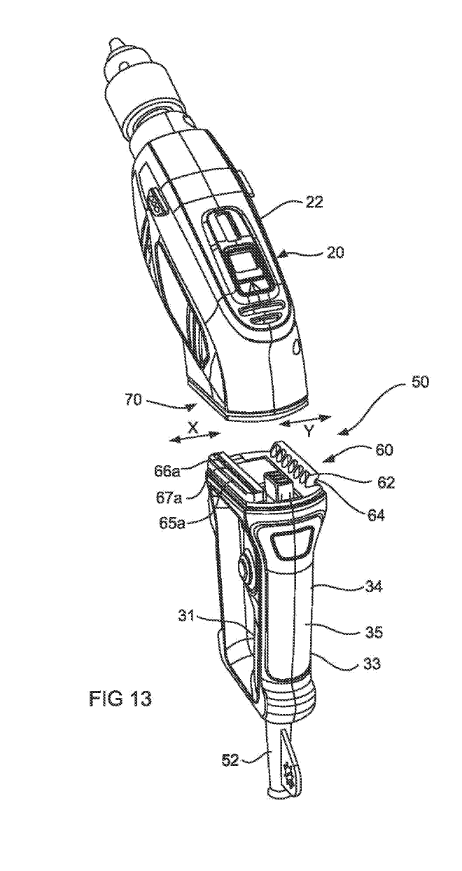

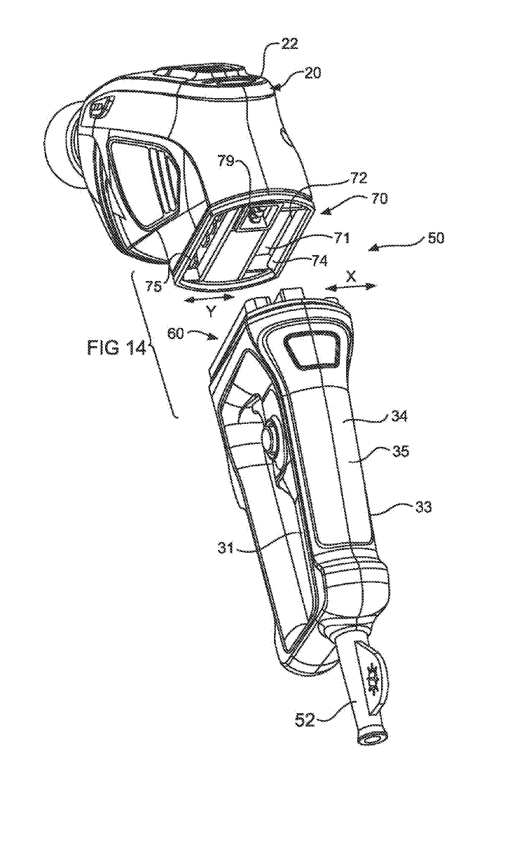

FIGS. 1 to 16 illustrate preferred embodiments of the invention in the form of a modular assembly 10 including an electrical device 20 and a power control module 30. The modular assembly 10 includes a connection arrangement 50 for releasably connecting the electrical device 20 and the power control module 30. The electrical device 20 may include any form of electrical device including a handheld power drill, handheld power saw, power screwdriver, power percussion/hammer drill and any other power tool that utilises a drive means and a driven member for driving movement of a working element relative to the power tool body. The electrical device 20 may include other forms of electrical devices including a light emitting device, such as a torch, a radio or a digital audio playback device. Accordingly, the electrical device 20 may be any device including an electrically powered functional component (not shown) such as an electric motor, an electric light emitting device, a microprocessor device or any other electrically powered device.

The connection arrangement 50 between the power control module 30 and the electrical device 20 facilitates removal and connection of the power control module 30 to a variety of modular electrical devices 20 of which the power drill modules illustrated in FIGS. 1 to 16 are only examples.

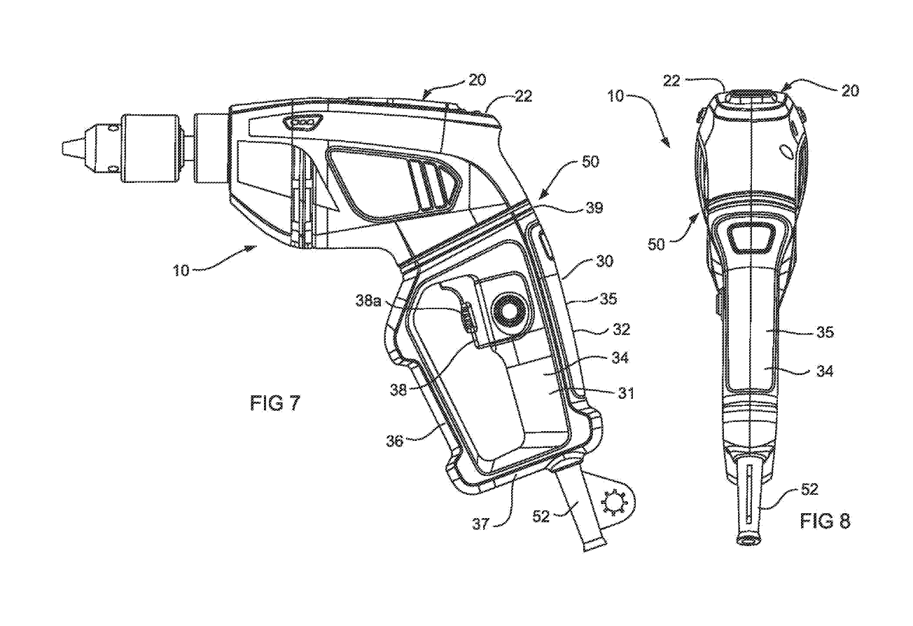

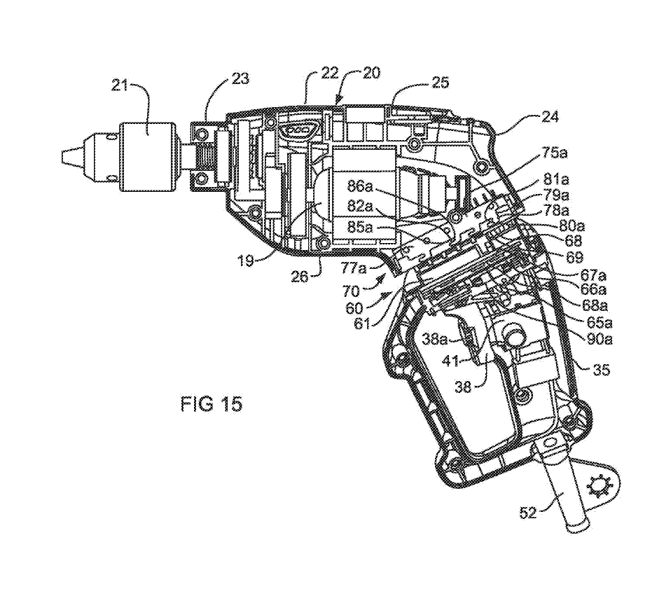

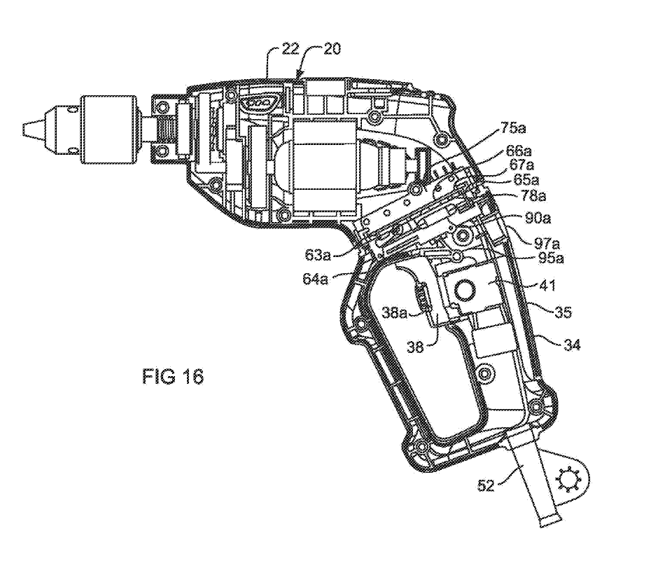

The power control module 30 includes a housing 32 including a handle portion 34. The handle portion 34 extends between a bottom 37 and an opposite top 39. The handle portion 34 also has a front end 36 and a rear end 35 and two opposite lateral sides 31, 33 extending between the front and rear ends 36, 35. As shown in FIGS. 7 to 16, the front end 36 of the handle portion 34 provides a guard for protection of a user's fingers when holding the handle. The front end 36 of the handle portion 34 is also effective for reducing the likelihood of inadvertent operation of the trigger mechanism 38 and can also be used to wind the cable 52 thereon. As shown in FIGS. 15 and 16, the housing 32 contains a switch assembly 41 mounted within the housing 32. The housing 32 also includes an electric cable 52 extending from the housing 32 at the bottom 37 of the handle 34. The cable 52 is suitable for connection to a power supply such as an alternating current power supply. The cable 52 is connected to the switch assembly which is operable for supplying electrical power to the electrically powered functional component of the electrical device 20 when the power control module 30 and the electrical device 20 are in the assembled condition as shown in FIGS. 1, 4, 7, 8 and 16. The power control module 30 includes a trigger mechanism 38 mounted to the front end 36 of the housing 32. The trigger mechanism 38 is operated manually to actuate the switch assembly 41 between operative and inoperative conditions to respectively supply and cut the supply of electrical power to the electrically powered functional component of the electrical device 20.

In another form, the housing 32 may contain an on board power supply such as a rechargeable battery. The battery may include an electrochemical cell, a supercapacitor or a hybrid capacitor or combinations thereof. The on board power supply can be connected to the switch assembly which is operable for supplying electrical power to the electrically powered functional component of the electrical device 20 when the power control module 30 and the electrical device 20 are in the assembled condition as shown in FIGS. 1, 4, 7, 8 and 16.

The connection arrangement 50 includes a first connecting portion 60 and second connecting portion 70. The first connecting portion 60 may be associated with either the power control module 30 or the electrical device 20 and the second connecting portion 70 may be associated with the other one of the power control module 30 and the electrical device 20. In the embodiment illustrated in the Figures, the first connecting portion 60 is associated with the power control module 30 and the second connecting portion 70 is associated with the electrical device 20.

In general, the first connecting portion 60 includes at least one first locking member 65 and the second connecting portion 70 includes at least one second locking member 75. As will be described in more detail below, the connection arrangement 50 facilitates connection of the power control module 30 and one of the modular electrical devices 20 by first moving the module 30 and the electrical device 20, and the first connecting portion 60 and the second connecting portion 70, towards each other so that the first and second connection portions 60, 70 come into engagement. Once the first and second connection portions 60, 70 come into engagement the first and second locking members 65, 75 are in a locking position. In the locking position, the first and second locking members 65, 75 are movable relative to each other between an unlocked position and a locked position. In the unlocked position, the first and second locking members 65, 75 are movable relative to each other such that the first and second connection portions 60, 70, and the power control module 30 and the modular electrical device 20, can be separated from each other. In the locked position, the first and second locking members 65, 75 are not movable relative to each other such that the first and second connection portions 60, 70, and the power control module 30 and the modular electrical device 20, are securely maintained in engagement with each other. Furthermore, the first and second locking members 65, 75 are configured such that in the locked position the first and second connection portions 60, 70 are compressed together. This can be achieved by configuring the first and second locking members 65, 75 to engage each other in an interference fit.

Thus, when the first and second locking members 65, 75 are in the locked position the power control module 30 and the modular electrical device 20 are compressed, or clamped, together so as to effectively render the power control module 30 and the modular electrical device 20 as a unitary, integrated assembly. Thus, an advantage of the power control module 30 and the modular electrical device 20 is that, when in use, the power control module 30 and the modular electrical device 20 have the feel of a unitary and integrated device in which any play between the power control module 30 and the modular electrical device 20 is substantially eliminated. Accordingly, in embodiments in which the power control module 30 includes a handle through which force is applied to the combined power control module 30 and the modular electrical device 20, for example when applying pressure through the handle of the power control module 30 and the modular electrical device 20 upon a workpiece the feel that is provided to the user is one of a unitary and integrated device enabling precision work to be carried out on the workpiece.

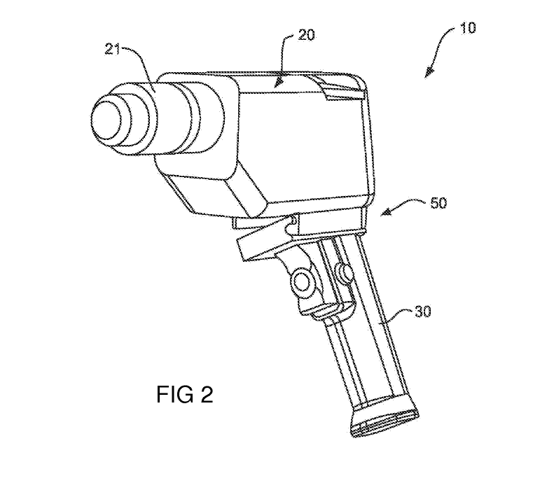

In the embodiment illustrated in the Figures, and as can best be seen in FIGS. 2 to 69, 10 and 12 to 15, the first connecting portion 60 includes a first connection member 62 and the first locking member 65. The first locking member 65 is spaced apart from the first connection member 62 along a first connecting axis X. The second connecting portion 70 includes a second connection member 72 and the second locking member 75 spaced apart from the second connection member 72 along a second connecting axis Y. As will be described in more detail below the connection arrangement 50 facilitates connection of the power control module 30 and one of the modular electrical devices 20 by first moving the module 30 and the electrical device 20, and the first connecting portion 60 and the second connecting portion 70, towards each other with the first connecting axis X converging with the second connecting axis Y so that the first and second connection members 62, 72 come into engagement as shown in FIGS. 2, 3, 9, 10 and 15.

When the first and second connection members 62, 72 are in engagement the power control module 30 and the modular electrical device 20 are then tilted relative to each other so that the first connecting axis X and the second connecting axis Y move in an arc or pivot relative to each other so that the first locking member 65 and the second locking member 75 also move in an arc or pivot relative to each other from a separated position until coming into engagement with each other in a locking position as shown in FIGS. 1, 4, 7, 8 and 16. In the locking position the first locking member 65 and the second locking member 75 are moveable relative to each other between a locked position and an unlocked position thereby providing a locked condition and an unlocked condition respectively. In the locked condition the first locking member 65 and the second locking member 75 are locked and compressed together and in the unlocked condition the first locking member 65 and the second locking member 75 are free to move relative to each other.

The connection arrangement 50 also facilitates separation of the power control module 30 and one of the modular electrical devices 20. This is achieved by moving the first locking member 65 and the second locking member 75 relative to each other from the locked position to the unlocked position and thereby changing the condition of the first locking member 65 and the second locking member 75 from the locked condition to the unlocked condition. The power control module 30 and the modular electrical device 20 may then be tilted relative to each other so that the first connecting axis X and the second connecting axis Y move away from each other in an arc or pivoting motion to the position illustrated in FIGS. 2, 3, 9, 10 and 15. When the power control module 30 and the electrical device 20 are tilted so that the first connecting axis X and the second connecting axis Y move away from each other the first locking member 65 and the second locking member 75 also move in an arc or pivot away from each other. Then the module 30 and the electrical device 20 may be moved away from each other with the first connecting axis X converging with the second connecting axis Y so that the first and second connection members 62, 72 are moved out of engagement to the position illustrated in FIGS. 11 to 14.

In another form of the connection arrangement 50, not illustrated, the first connecting portion 60 includes a pair of the first locking members 65. The pair of first locking members 65 are spaced apart from each other along the first connecting axis X. The second connecting portion 70 includes a pair of the second locking members 75 spaced apart from each other along a second connecting axis Y. The connection arrangement 50 facilitates connection of the power control module 30 and one of the modular electrical devices 20 by first moving the module 30 and the electrical device 20, and the first connecting portion 60 and the second connecting portion 70, towards each other in a direction substantially perpendicular to the first connecting axis X and the second connecting axis Y so that the pairs of first and second locking members 65, 75 are in a locking position. In the locking position, when the first and second connection portions 60, 70 are mated together, the pairs of first and second locking members 65, 75 are movable relative to each other between a locked position and an unlocked position, wherein in the locked position the first and second connection 60, 70 portions are locked and compressed together and in the unlocked position the first and second connection portions 60, 70 are separable.

Preferred embodiments of the connection arrangement 50 will now be described in more detail below with reference to the embodiments illustrated in the Figures. As mentioned above, the first connecting portion 60 includes the first connection member 62 and the first locking member 65. The first connecting portion 60 is arranged along an upper portion of the housing 32 at the top 39 of the handle 34. Thus, the first connecting portion 60 is positioned distally from the bottom 37 of the handle 34 and the cable 52 extending therefrom. The first connecting portion 60 is also positioned immediately adjacent to the trigger 38.

The first connection member 62 includes an elongate slot 64 extending generally in a direction Q from the rear 35 of the handle 34 to the front 36 of the handle 34. The slot 64 of the first connection member 62 extends beyond and overhangs the front 36 of the handle 34. The slot 64 also extends generally in a direction transverse to a direction A extending from the bottom 37 to the top 39 of the handle 34. Accordingly, the power control module 30 is configured so that when a user grips the handle portion 34 the user's forefinger wraps around the trigger mechanism 38 and the base of the user's palm rests against the rear end 35 of the of the handle portion 34 and the direction Q in which the slot 64 generally extends is also generally in the direction from the base of the user's palm towards the user's forefinger when the user grips the handle 34.

The first locking member 65 is spaced apart from the first connection member 62 along the first connecting axis X. In the embodiment illustrated in the figures the first connecting axis X is generally transverse to a direction of the axis A extending from the bottom 37 to the top 39 of the handle 34 and is generally transverse to the direction Q extending from the rear 35 to the front 36 of the handle 34. In the illustrated embodiments, the axis X is substantially perpendicular to the direction A and is substantially perpendicular to the direction Q. The first connecting axis X also extends in a direction from one of the opposite lateral sides 31, 33 of the handle 34 to the other one of the opposite lateral sides 31, 33. The first locking member 65 includes a catch 66 upstanding from a first connection face 61 of the first connecting portion 60 wherein the first connection face 61 extends in a plane aligned with the first connecting axis X and the direction Q from the rear 35 to the front 36 of the handle 34.

The second connecting portion 70 is arranged on a housing 22 of the device 20. In the embodiment illustrated in the Figures, in which the device 20 is a power drill, the housing 22 contains an electric motor assembly 19 connected to a driven member 21 in the form of a chuck. The driven member 21 projects from a forward end 23 of the housing 22. Opposite the forward end 23 is a rear end 24 of the housing 22. The housing 22 also includes a top end 25 and an opposite bottom end 26. The housing 22 also includes a pair of opposite lateral sides 27, 28. The top and bottom ends 25, 26 each extend between the forward end 23 and the rear end 24 of the housing 22. The second connecting portion 70 is provided at the bottom end 26 of the housing 22. As can be appreciated, in other embodiments in which the device 20 is a power drill module, or some other form of power tool or electrical device module, the second connecting portion 70 may not necessarily be located at a bottom end 26 of the housing 22 but may be located anywhere on the housing 22 such as the top end 25, one of the lateral sides 27, 28 or may be positioned on any one or more of the top and bottom ends 25, 26 and the lateral sides 27, 28 of the housing 22.

As mentioned above, the second connecting portion 70 includes the second connection member 72. The second connection member 72 is in the form of a ridge 74 extending generally in a direction R from the forward end 23 to the rear end 24 of the housing 22. Also as mentioned above, the second connecting portion 70 includes the second locking member 75 which is spaced apart from the second connection member 72 along the second connecting axis Y. The second connecting axis X is generally transverse to a direction B extending from the bottom end 26 to the top end 25 of the housing 22 and is generally transverse to the direction R extending from the forward end 23 to the rear end 24 of the housing 22. In the embodiments illustrated, the axis Y is substantially perpendicular to the direction B and is substantially perpendicular to the direction R.

The second connecting axis Y also extends in a direction from one of the pair of opposite lateral sides 27, 28 to the other one of the pair of opposite lateral sides 27, 28 of the housing 22. The second connecting portion 70 includes a second connection face 71 that extends in a plane aligned with the second connecting axis Y and the direction R from the forward end 23 to the rear end 24 of the housing 22.

The interaction between the first connecting portion 60 and the second connecting portion 70, in the embodiment of the connection arrangement 50 illustrated in the Figures, will now be explained in more detail. In order to mate the first connecting portion 60 and the second connecting portion 70 a user must hold the power control module 30 and the device 20 relative to each other so that the front 36 of the module 30 faces towards the forward end 23 of the device 20 and the rear 35 of the module 30 is positioned substantially in alignment with the rear end 24 of the device 20. In this orientation, the direction Q from the rear 35 to the front 36 of the handle 34 and the direction R from the forward end 23 to the rear end 24 of the housing 22 of the device 20 are substantially in alignment. The module 30 must also be held relative to the device 20 such that the first connecting axis X is angularly displaced and converges with the second connecting axis Y. In other words, the first connection face 61 is positioned at an angle to the second connection face 71. The first and second connection members 62, 72 are then moved towards each other such that the ridge 74 fits within the slot 64. The slot 64 has a curved profile and the ridge 74 also has a curved profile to enable a user to subsequently pivot the module 30 relative to the device 20 such that the first connection face 61 pivots towards the second connection face 71 such that the first locking member 65 also pivots in an arc towards the second locking member 75 until the first locking member 65 and the second locking member 75 come into engagement with each other. The user must then apply lateral force to the one of the sides 33 of the handle 34 opposite the side of the connection face 61 where the first locking member 65 is located in a direction towards the opposite side 31 of the handle 34 until the first and second locking members 65, 75 engage each other in a locked position. In this position, the first connection face 61 is positioned face to face with the second connection face 71.

In the embodiment illustrated in FIGS. 1 to 6, the first locking member 65 is in the form of a catch 66 and the second locking member 75 is an anchor in the form of a rod 77. The catch 66 is elongated in the direction of the axis Q and the rod is elongated in the direction of the axis R. The catch 66 has a hook shaped profile and includes an opening 67 that is elongated in the direction of the axis Q and is arranged to receive a rod 77 of the second locking member 75 when the first and second locking members 65, 75 are moved to the locking position wherein the first and second connection faces 61, 71 are face to face with each other. The catch 66 includes a biasing mechanism (not shown) that is operable to cause the catch 66 to move such that the rod 77 is received within the opening 67. The catch 66 is also connected to a manually operated actuator (not shown) that is operable by a user to hold the catch 66 in position with the rod 77 received within the opening 67 to prevent separation of the rod 77 from the catch 66 and thereby prevent separation of the first and second locking members 65, 75.

In the embodiment illustrated in FIGS. 7 to 16, the first locking member 65a includes a catch in the form of a plate 66a including a plurality of apertures 67a arranged in a row. The second locking member 75a includes an anchor in the form of a base 77a including a plurality of hook members 78a arranged in a row and extending from the base 77a. The hook members 78a each include an upright portion 79a extending from the base 77a and a transverse portion 80a extending forward from the upright portion 79a. The transverse portion 80a has a tapering edge 82a that faces towards the base 77a. Thus, each of the hook members 78a defines a forwardly extending slot 81 a between the base 77a and the tapering edge 82a of the transverse portion 80a. The tapering edge 82a of the transverse portion 80a provides the slot 81 a with a tapered profile such that the slot 81 a has an open end 85a and an opposite closed end 86a wherein the open end 85a has a greater width dimension than the closed end 86a. The slot 81a tapers from the wider open end 85a to the narrower closed end 86a.

Each of the hook members 78a of the second locking member 75a is configured to be received within a respective one of the apertures 67a in the sheet 66a of the second locking member 65a. However, the plate 66a and the plurality of apertures 67a of the first locking member 65a can move linearly in a fore and aft direction relative to the housing 22 of the device 20. The plate 66a and the plurality of apertures 67a are biased by a biasing member 90a, which may be a helical spring or any other form of biasing member, towards a resting position that is in the aft direction in which the apertures 67a are not aligned with the hook members 78a and so cannot receive the hook members 78a therethrough. The first locking member 65a includes a pivoting detent 64a that is operable to pivot between a position in which the detent 64a abuts against an abutting surface 63a of the plate 66a and a position in which the detent 64a does not abut against the abutting surface 63a. When the detent 64a abuts the abutting surface 63a it maintains the plate 66a in a position that is forward of the resting position and counteracts the biasing force applied by the biasing member 78a so as to align the apertures 67a in the sheet 66a of the second locking member 65a with the hook members 78a of the second locking member 75a. When the hook members 78a are aligned with the apertures 67a they may be received through the apertures 67a in the sheet 66a of the second locking member 65a. When the hook members 78a are received through the apertures 67a one of the hook members 78a engages and moves the detent 64a out of abutment with the abutting surface 63a to allow the biasing member 78a to move the plate 66a to the aft resting position.

In another form (not shown) one of the hook members 78a can include a tapered surface that engages a surface of the plate 66a surrounding one of the apertures 67a to actuate the plate 66a against the biasing force applied by the biasing member 90a to a position in which the apertures 67a of the first locking member 65a are aligned with the hook members 78a to thereby receive the hook members 78a therethrough.

When the hook members 78a are initially received within the apertures 67a the first locking member 65a and the second locking member 75a and the plate 66a is in the forward position the first and second locking members 65a, 75a are in the unlocked position relative to each other. After the hook members 78a are received within the apertures 67a the plate 66a and the plurality of apertures 67a can move linearly to the aft position and relative to the hook members 78a due to the biasing force applied by the biasing member 90a. When the plate 66a and the apertures 67a are in the aft position, as shown in FIG. 16, an edge region 68a adjacent to each of the apertures 67a is received within a respective one of the forwardly extending slots 81a of the hook members 78a. When the edge region 68a adjacent to each of the apertures 67a is received within a respective one of the slots 81a the first locking member 65a and the second locking member 75a are in the locked condition. When in the locked condition the first locking member 65a and the second locking member 75a are prevented from moving relative to each other thereby locking the first locking member 65a and the second locking member 75a together.

As the plate 66a begins to move to the aft position the edge regions 68a of the apertures 67a are initially received through the open ends 85a of the slots 81a. However, as the plate 66a continues to move further towards the aft position the tapering edge 82a begins to engage the edge region 68a of the aperture 67a. As the plate 66a moves yet further towards the aft position the tapering edge 82a engages the edge region 68a of the aperture 67a in a direction transverse to the direction of movement of the plate 66a relative to the hook members 78a with increasing force. In other words, the tapering edge 82a engages the edge region 68a of the aperture 67a in an interference fit. This is because the plate 66a is fixed to the first connecting portion 60 of the housing 22 of the electrical device 20 from movement transverse to the direction of movement of the plate 66a relative to the hook members 78a and the hook members 78a are fixed from relative to the second connecting portion 70 of the housing 32 of the power control module 30 from movement transverse to the direction of movement of the plate 66a relative to the hook members 78a.

Movement of the plate 66a of the first locking member 65a in the aft direction relative to the hook members 78a of the second locking member 75a results in abutment between the edge region 68a of the aperture 67a of the plate 66a and the tapering edge 82a of the hook member 78a. Abutment between the edge region 68a of the aperture 67a of the plate 66a and the tapering edge 82a of the hook member 78a results in preventing relative movement of the first and second locking members 65a, 75a. Because the edge 82a of the hook member 78a is tapered it is possible, by applying force to move the plate 66a in the aft direction, to impart an increasing amount of force of engagement of the edge 82a of the hook member 78a and the edge region 68a of the aperture 67a of the plate 66a and thereby impart a compression force between the first connecting portion 60 of the housing 22 of the electrical device 20 and the second connecting portion 70 of the housing 32 of the power control module 30. Thus, the first and second locking members 65a, 75a are configured to compress the first connecting portion 60 of the housing 22 of the electrical device 20 and the second connecting portion 70 of the housing 32 of the power control module 30 together. Thus, when the first and second locking members 65a, 75a are in the locked position the power control module 30 and the modular electrical device 20 are compressed, or clamped, together so as to effectively render the power control module 30 and the modular electrical device 20 as a unitary, integrated assembly.

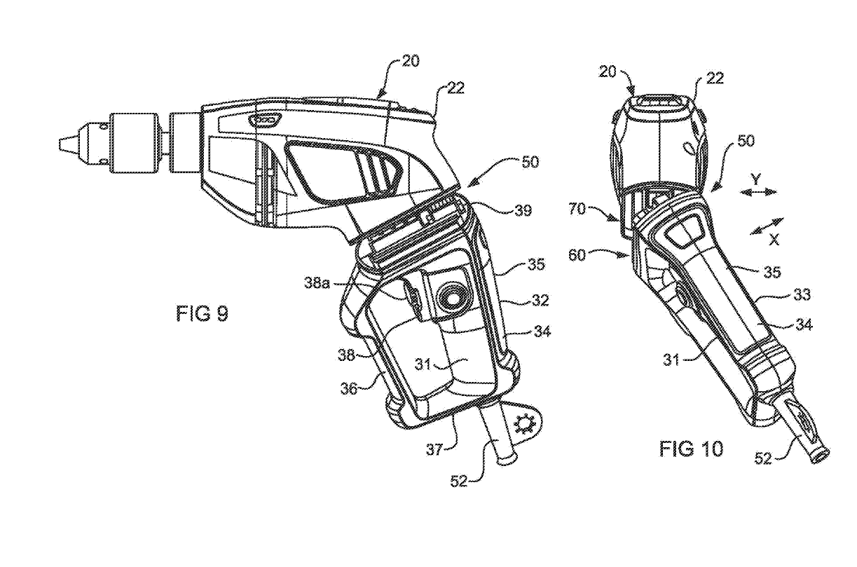

When it is required to separate the power control module 30 and the device 20 from each other the first connecting portion 60 and the second connecting portion 70 must be separated. A button 97a on the rear end 35 of the of the handle portion 34 which is mechanically coupled to the plate 66a and the plurality of apertures 67a of the first locking member 65a. Depressing the button 97a actuates the plate 66a and the plurality of apertures 67a in the forward direction to the position in which the apertures 67a of the first locking member 65a are aligned with the hook members 78a. When the apertures 67a of the first locking member 65a are aligned with the hook members 78a the power control module 30 and the device 20 may be tilted relative to each other such that the first and second locking members 65, 75 pivot about the first and second connection members 62, 72 to the separated position illustrated in FIGS. 9 and 10. When the hook members 78a are removed from within the apertures 67a in the sheet 66a of the second locking member 65a the hook members 78a disengages the detent 64a. The detent 64a is biased into abutment with the abutting surface 63a of the sheet 66a to maintain the plate 66a in the forward position ready for another reinsertion of the hook members 78a into the apertures 67a in the sheet 66a of the second locking member 65a.

In another form of the connection arrangement 50, not illustrated, the first connecting portion 60 includes a pair of the first locking members 65a in the form of a pair of the plates 66a each including a plurality of apertures 67a arranged in a row. The pair of first locking members 65a are spaced apart from each other along the first connecting axis X. The second connecting portion 70 includes a pair of the second locking members 75a in the form of a pair of the bases 77a each including a plurality of hook members 78a arranged in a row and extending from each of the bases 77a. The second locking members 75a are spaced apart from each other along a second connecting axis Y. The connection arrangement 50 facilitates connection of the power control module 30 and one of the modular electrical devices 20 by first moving the module 30 and the electrical device 20, and the first connecting portion 60 and the second connecting portion 70, towards each other in a direction substantially perpendicular to the first connecting axis X and the second connecting axis Y so that the pairs of first and second locking members 65a, 75a are in a locking position. The pairs of first and second locking members 65a, 75a operate substantially the same as the locking members 65a, 75a described above. In the locking position, when the first and second connection portions 60, 70 are mated together, the pairs of first and second locking members 65a, 75a are movable relative to each other between a locked position and an unlocked position, wherein in the locked position the first and second connection portions 60, 70 are locked and compressed together and in the unlocked position the first and second connection portions 60, 70 are separable.

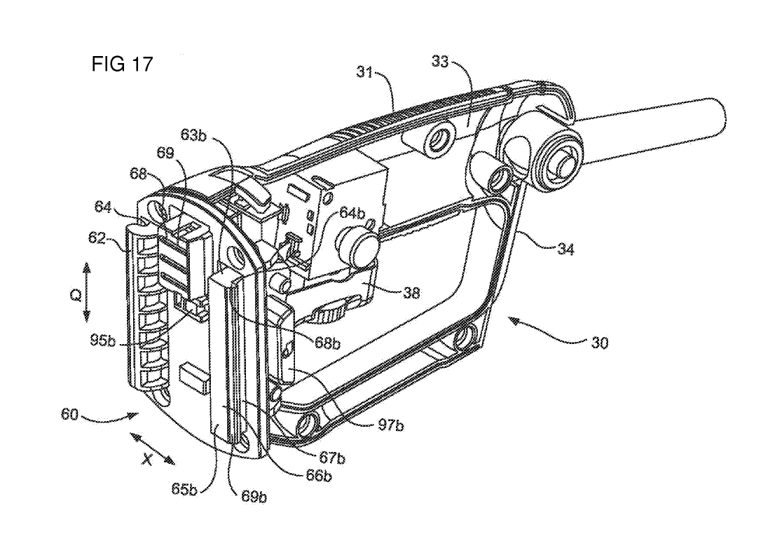

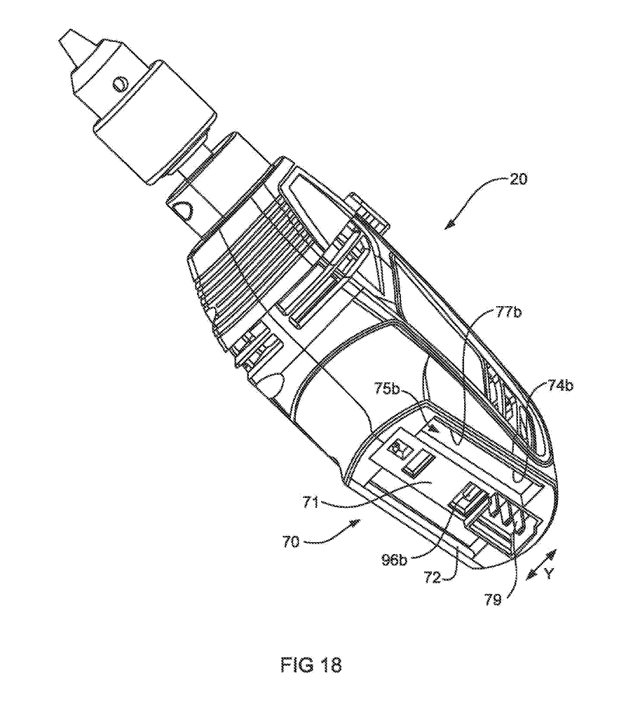

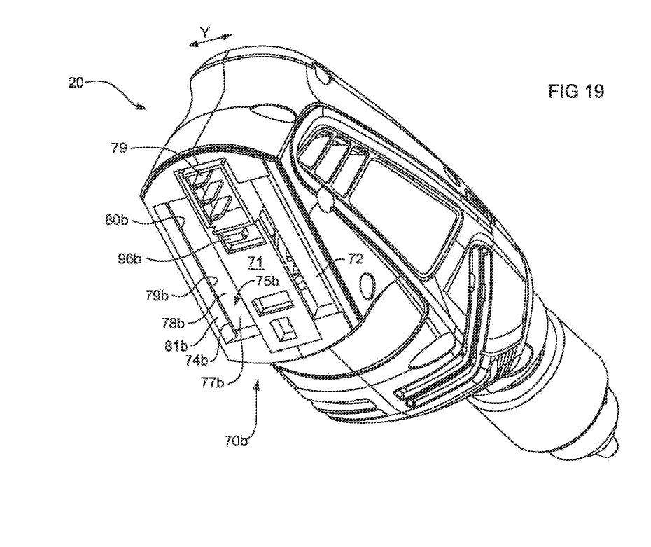

In the embodiment illustrated in FIGS. 17 to 19, the modular assembly includes a connection arrangement for releasably connecting the electrical device 20 and the power control module 30. The connection arrangement includes the first connecting portion 60 and the second connecting portion 70. The first connecting portion 60 includes a first connection member 62 and the first locking member 65b. The first locking member 65b is spaced apart from the first connection member 62 along the first connecting axis X. The second connecting portion 70 includes a second connection member 72 and the second locking member 75b spaced apart from the second connection member 72 along the second connecting axis Y. The connection arrangement facilitates connection of the power control module 30 and one of the modular electrical devices 20 by first moving the module 30 and the electrical device 20, and the first connecting portion 60 and the second connecting portion 70, towards each other with the first connecting axis X converging with the second connecting axis Y so that the first and second connection members 62, 72 come into engagement in the same manner as illustrated in the embodiment shown in FIGS. 2, 3, 9, 10 and 15.

When the first and second connection members 62, 72 are in engagement the power control module 30 and the modular electrical device 20 are then tilted relative to each other so that the first connecting axis X and the second connecting axis Y move in an arc or pivot relative to each other so that the first locking member 65b and the second locking member 75b also move in an arc or pivot relative to each other from a separated position until coming into engagement with each other in a locking position in the same manner as illustrated in the embodiment shown in FIGS. 1, 4, 7, 8 and 16. In the locking position the first locking member 65b and the second locking member 75b are moveable relative to each other between a locked position and an unlocked position thereby providing a locked condition and an unlocked condition respectively. In the locked condition the first locking member 65b and the second locking member 75b are locked and compressed together and in the unlocked condition the first locking member 65b and the second locking member 75b are free to move relative to each other.

The connection arrangement 50b also facilitates separation of the power control module 30 and one of the modular electrical devices 20. This is achieved by moving the first locking member 65b and the second locking member 75b relative to each other from the locked position to the unlocked position and thereby changing the condition of the first locking member 65b and the second locking member 75b from the locked condition to the unlocked condition. The power control module 30 and the modular electrical device 20 may then be tilted relative to each other so that the first connecting axis X and the second connecting axis Y move away from each other in an arc or pivoting motion to the position illustrated in FIGS. 2, 3, 9, 10 and 15. When the power control module 30 and the electrical device 20 are tilted so that the first connecting axis X and the second connecting axis Y move away from each other the first locking member 65b and the second locking member 75b also move in an arc or pivot away from each other. Then the module 30 and the electrical device 20 may be moved away from each other with the first connecting axis X converging with the second connecting axis Y so that the first and second connection members 62, 72 are moved out of engagement.

In the embodiment illustrated in FIGS. 17 to 19, the first locking member 65b includes a catch 66b upstanding from the first connection face 61 of the first connecting portion 60. The catch 66b includes an upright portion 63b and a transverse portion 68b in the form of an elongated ridge depending from the upright portion 63b. The transverse portion 68b has a first abutting surface 64b that faces towards, and is substantially parallel to, the first connection face 61. The first abutting surface 64b may be parallel or may slope relative to the first connection face 61. A groove 67b is defined between the transverse portion 68b and the first connection face 61. The transverse portion 68b also has a tapering or sloping edge 69b that faces away from, and is sloped relative to, the first connection face 61. The second locking member 75b of the second connection portion 70 includes an anchor in the form of an elongated ridge 74b defining an elongated recess 77b within the second connection face 71. The elongated recess 77b includes an upright recess portion 78b and a transverse recess portion 79b depending from the upright recess portion 78b. The transverse recess portion 79b has a second abutting surface 80b located below and facing away from the second connection face 71.

Once the first and second connection portions 60, 70 come into engagement the first and second locking members 65b, 75b are in the locking position. In the locking position, the catch 66b of the first locking member 65b is positioned within the recess 77b of the second locking member 75b. In the locking position the first and second locking members 65b, 75b are movable relative to each other between an unlocked position and a locked position. In the unlocked position the upright portion 63b and the transverse portion 68b of the first locking member 65b are located within the upright recess portion 78b of the second locking member 75b. In the locked position, the upright portion 63b of the first locking member 65b is located within the upright recess portion 78b of the second locking member 75b and the transverse portion 68b of the first locking member 65b is located within the transverse recess portion 79b of the second locking member 65b such that the first and second abutting surfaces 64b, 80b are in face to face contact and abut each other. The first abutting surface 64b may be sloped relative to the first connection face 61 such that when in abutment with the second abutting surface 80b a compression force, or a greater compression force, is applied between the first and second connection faces 61, 71. In the unlocked position, the first and second locking members 65b, 75b are movable relative to each other such that the first and second connection portions 60, 70, and the power control module 30 and the modular electrical device 20, can be separated from each other. In the locked position, the first and second locking members 65b, 75b are not movable relative to each other such that the first and second connection portions 60, 70, and the power control module 30 and the modular electrical device 20, are securely maintained in engagement with each other. Furthermore, the first and second locking members 65b, 75b are configured such that in the locked position the first and second connection portions 60, 70 are compressed together.

The first locking member 65b is biased by a spring or like biasing means towards a position in which when the first and second connection members 62, 72 are in engagement and the power control module 30 and the modular electrical device 20 are tilted relative to each other so that the first locking member 65b and the second locking member 75b are moved towards each other the contact surface 81b is engaged by the sloping edge 69b of the catch 66b. The second connection face 71 includes a sloping contact surface 81b located adjacent to the upright recess portion 78b. Continuing to move the first locking member 65b and the second locking member 75b towards each other causes the sloping edge 69b of the catch to slide over the sloping contact surface 81b and to be actuated against the biasing force acting on the first locking member 65b such that the sloping edge 69b of the catch clears the sloping contact surface 81b. When the sloping edge 69b clears the sloping contact surface 81b the upright portion 63b and the transverse portion 68b of the first locking member 65b can enter the upright recess portion 78b of the second locking member 75b. Continuing to move the first locking member 65b and the second locking member 75b towards each other causes the upright portion 63b and the transverse portion 68b of the first locking member 65b to enter the upright recess portion 78b to an extent that the transverse portion 68b of the first locking member 65b reaches the transverse recess portion 79b of the second locking member 75b. The transverse portion 68b of the first locking member 65b is then biased by the biasing force into the transverse recess portion 79b of the second locking member 75b such that the first and second abutting surfaces 64b, 80b are in face to face contact and abut each other. As a result, the first locking member 65b and the second locking member 75b are in the locking position and, more particularly, are in the locked position in which the first locking member 65b and the second locking member 75b are locked together.

When it is required to separate the power control module 30 and the device 20 from each other the first connecting portion 60 and the second connecting portion 70 must be separated. A button 97b on one of the lateral sides 31, 33 of the handle 34 is mechanically coupled to the first locking member 65b. Depressing the button 97b actuates the first locking member 65b against the biasing force acting on the first locking member 65b such that the first locking member 65b is moved from the locked position to the unlocked position. The power control module 30 and the modular electrical device 20 can then be tilted relative to each other so that the first locking member 65b and the second locking member 75b also move in an arc or pivot relative to each other from the locking position to the separated position. The first and second connection members 62, 72 can then be moved out of engagement such that the power control module 30 and the modular electrical device 20 are thereby completely separated.

The power control module 30 also includes a trigger lock for preventing operation of the trigger 38 unless the first connecting portion 60 and the second connecting portion 70 are mated together and the first locking member 65 and the second locking member 75 are locked together. The trigger lock is also operable for preventing operation of the trigger 38 when the button 97a, 97b is depressed to separate the power control module 30 and the device 20 from each other. The trigger lock for preventing operation of the trigger 38 may take any suitable form. In the embodiment illustrated in FIGS. 7 to 16 the trigger lock for preventing operation of the trigger 38 is in the form of a pivoting member 95a that pivots fore and aft as the plate 66a including the plurality of apertures 67a moves fore and aft. When the plate 66a is in the forward position the pivoting member 95a abuts against a rearward surface of the trigger 38 to prevent depression of the trigger 38 and transmission of electrical current from the electrical power source via the cable 52 to the motor 19 or other electrically powered functional component of the device 20. When the plate 66a is in the rearward position, such as when the first locking member 65a and the second locking member 75a are in the locked condition, the pivoting member 95a does not abut against a rearward surface of the trigger 38 to enable depression of the trigger 38 and transmission of electrical current from the electrical power source via the cable 52 to the motor 19 or other electrically powered functional component of the device 20. In the embodiment in FIGS. 17 to 19 the trigger lock is in the form of a depressable member 95b in the first connecting face 61 of the power control module 30 that is engaged by a protuberance 96b on the second connecting face 71 of the electrical device 20 when the first connecting portion 60 and the second connecting portion 70 are engaged. The trigger 38 can only be operated when the depressable member 95b is depressed by the protuberance 96b when the power control module 30 and the electrical device 20 are engaged together. Furthermore, the power control module includes a second trigger lock (not shown) that is engaged when the button 97b for releasing or disengaging the first and second locking members 65b, 75b is depressed to prevent operation of the trigger 38. The second trigger lock is also operable for preventing the button 97b for releasing or disengaging the first and second locking members 65b, 75b from being depressed when the trigger 38 is in operation, namely when the trigger 38 is being depressed by a user's finger.

In each of the embodiments illustrated in the Figures, the first connecting portion 60 also includes a first electrical contact 69 that is positioned within a recess 68 within the first connection face 61 of the housing 32 of the module 30. The contact 69 is positioned within the recess 68 such that when the module 30 is separated from the device 20 a user cannot access the contact 69 or at least inadvertently touch the contact 69. The second connecting portion 70 also includes a second electrical contact 79 that projects from and is upstanding from the second connection face 71. The second contact 69 is arranged so as to fit within the recess 68 and to engage the first electrical contact 69 when the first connecting portion 60 mates with the second connecting portion 70 in the manner described above. The first electrical contact 69 of the module 30 is in electrical contact with the switch assembly of the module 30 and the second electrical contact 69 is in electrical contact with the motor 19 or any other electrically powered functional component of the device 20. Thus, when the first and second electrical contacts 69, 79 are in engagement with each other manual operation of the trigger 38 actuates the switch assembly to facilitate the transmission of electrical current from the electrical power source via the cable 52 to the motor 19 or other electrically powered functional component of the device 20 to thereby operate the device 20.

In the embodiments illustrated in FIGS. 1 to 6 and 17 to 19, the first connection member 62 includes an elongate slot 64 extending in the direction Q and the second connection member 72 is in the form of ridge 74 extending generally in the direction R. Also, the first locking member 65, 65b is in the form of a catch 66, 66b having an opening or groove 67, 67b that is elongated in the direction of the axis Q and the second locking member 75, 75b is an anchor in the form of a rod 77 or ridge 74b defining a recess 77b elongated in the direction of the axis R. When the first connecting portion 60 and the second connecting portion 70 mate with each other the first connection member 62 and the second connection member 72 come into engagement with each other as a result of the ridge 74 fitting within the slot 64 and the first and second locking members 65, 65b, 75, 75b engage each other such that the elongated opening or groove 67, 67b of the catch 66, 66b receives the rod 77 or ridge 74b of the second locking member 75, 75b when the first and second locking members 65, 65b, 75, 75b are moved to the locking position. In this position, the first connection face 61 is positioned face to face with the second connection face 71.

An advantage of the embodiments of the invention described above is that the first connection member 62 and the second connection member 72 contact and engage each other along an elongated length in the directions Q and R, which when the first connection member 62 and the second connection member 72 are in contact, the directions Q and R are in the same direction. Also, the first and second locking members 65, 65a, 65b, 75, 75a, 75b contact and engage each other along an elongated length in the directions Q and R. Thus, when a user operates the assembled electrical device 20 and power control module 30 by gripping the handle 34 and applies a force to the handle 34 in a direction from the rear of the handle 35 towards the front of the handle 36 that force is transmitted to the device 20 along the connection between the first connection member 62 and the second connection member 72 and the first and second locking members 65, 65a, 65b, 75, 75a, 75b along an elongated length in the directions Q and R. In so doing, the load is spread between the first connection member 62 and the second connection member 72 and the first and second locking members 65, 65a, 65b, 75, 75a, 75b and is spread along the respective elongated lengths thereof. Also, any load applied in a lateral direction to the handle 35 in a direction along the axis X will result in a load being transferred to or from the handle 34 from or to the device 20 which load is spread along the respective elongated lengths of the first connection member 62 and the second connection member 72 and the first and second locking members 65, 65a, 65b, 75, 75a, 75b.

As shown in FIGS. 1 to 5, 7, 9, 11, 15 and 16 the trigger mechanism 38 includes a dial 38a that is operably connected to a device that varies the current and/or voltage flow from the power supply to the electrically powered functional component of the electrical device 20 when the power control module 30 and the electrical device 20 are in the assembled condition as shown in FIGS. 1, 4, 7, 8 and 16. The device that varies the current and or voltage from the power supply to the electrical device 20 may be any device suitable for this purpose and may include a resistor constructed so that its resistance value may be changed without interrupting the circuit to which it is connected, also known as variable resistor. The dial 38a is operable by a user to adjust the variable resistor to vary the flow of current from the power supply to the electrical device 20.

The first electrical contact 69 includes three separate contacts that are positioned within the recess 68 within the first connection face 61 of the housing 32 of the power control module 30. One electrical contact is a negative terminal and the other two are positive terminals. One positive terminal receives current in an on or off fashion whereas the other positive terminal receives variable current and/or voltage from the trigger mechanism 38. The second connecting portion 70 also includes a second electrical contact 79. However, the second electrical contact 79 includes two electrical contacts, one for contacting the negative terminal and the other for contacting either one of the positive terminals so as to receive current in an on or off fashion or to receive a variable current or voltage. The aforementioned arrangement enables the power control module 30 to mate with a variety of modular electrical devices 20 and to enable the trigger mechanism 38 to supply power either in an on or off fashion or in a variable fashion as appropriate for the electrical device 20.

In another form of the power control module (not shown) which includes either and integral or a removal power supply battery providing DC power, as opposed to AC power in the previous embodiments, the first electrical contact includes five separate contacts that are positioned within the recess within the first connection face of the housing of the power control module. Two electrical contacts reversibly act as positive and negative terminals for reversibly providing power to the tool module to provide, for example, forward and reverse modes of operation of the tool module. Another, two terminals act as positive and negative terminals for another electrically powered device module for connection to the power control module, such as a light emitting device. Another terminal acts as a means for providing sensor signals to a charger when the power control module is mounted to a charger for charging the battery. The terminal feeds information to the charger about the amount of charge in the battery. The terminal may be connected to the battery to provide information about the voltage in the battery or to provide information about the resistance in the battery. Alternatively, the terminal may be connected to a sensor, such as a temperature sensor, to provide information about the charge in the battery. One positive terminal receives current in an on or off fashion whereas the other positive terminal receives variable current and/or voltage from the trigger mechanism 38. The second connecting portion 70 also includes a second electrical contact 79. However, the second electrical contact 79 includes two electrical contacts, one for contacting the negative terminal and the other for contacting either one of the positive terminals so as to receive current in an on or off fashion or to receive a variable current or voltage. The aforementioned arrangement enables the power control module 30 to mate with a variety of modular electrical devices 20 and to enable the trigger mechanism 38 to supply power either in an on or off fashion or in a variable fashion as appropriate for the electrical device 20.

Various forms of electrical device 20 that are connectable to the power control module 30 may include an electrically powered functional component that is capable of, or suited to, receiving a variable flow of current from the power supply. Examples of such electrical devices include power drills, angle grinders, disc or belt sanders, light emitting devices to name but a few. In such cases adjustment of the variable resistor by operation of the dial 38a in conjunction with manual operation of the trigger 38 results in varying the amount of the power supplied to the electrically powered functional component. In the case of electrically powered functional components that are electric motors adjustment of the variable resistor by operation of the dial 38a will result in adjustment of the speed of rotation of the motor and/or adjustment of the amount of torque supplied by the motor. In the case of electrically powered functional components that are light emitting device or other static electrically powered devices adjustment of the variable resistor by operation of the dial 38a will result in adjustment of the intensity of light emitted by the device or adjustment of the intensity of whatever output is associated with the electrically powered functional component.

Not all forms of electrical device 20 that are connectable to the power control module 30 may include an electrically powered functional component that is capable of, or suited to, a variable flow of current from the power supply and in such cases the power control module 30 and the electrical device 20 may include a device or mechanism for preventing the adjustment of the variable resistor and/or operation of the dial 38a.

As can be appreciated, an advantage of the fact that the power control module 30 includes a device that varies the current flow from the power supply to the electrically powered functional component of the electrical device 20 when the power control module 30 and the electrical device 20 are in the assembled condition is that each electrical device 20 capable of connection to the power control module 30 need not include such a device. Thus, by including the device that varies the current flow from the power supply to the electrically powered functional component of the electrical device 20 in the power control module 30 this component need not be included in each electrical device 20 which means that the cost of manufacturing the electrical devices 20 is reduced.

Although in the embodiments illustrated in the Figures, the device 20 is in a form of a power drill, it is to be appreciated that the device 20 may be any other device requiring electrical power to perform a function, such as any other handheld power tool such as a power saw, power screwdriver, power percussion or hammer drill, angle grinder, belt sander or disc sander, electrically powered gardening tool, such as a garden trimmer, edge trimmer, hedge trimmer. Alternatively, the device 20 may be of a type which does not include an electrically powered motor but may include another electrically powered functional component such as a light source, a radio or a digital sound recording playback device, to name but a few.

Finally, it is to be understood that various alterations, modifications and/or additions may be introduced into the constructions and arrangements of the parts previously described without departing from the spirit or ambit of the invention.

1. A connection arrangement for releasably connecting an electrical device and a power control module, the electrical device including an electrically powered functional component, the power control module including a device for controlling supply of electrical power to the functional component when the electrical device and the power control module are connected, the connection arrangement comprising:
a first connecting portion associated with one of the electrical device or the power control module and configured to interengage with a second connecting portion associated with the other one of the electrical device and the power control module,
wherein the first connecting portion comprises a first locking member and the second connecting portion comprises a second locking member,
wherein, when the first and second connection portions are engaged, the first and second locking members are movable relative to each other between an unlocked position in which the first and second connection portions are separable and a locked position in which the first and second connection portions are locked together.

2. The connection arrangement according to claim 1, wherein in the locked position the first and second connection portions are compressed together.

3. The connection arrangement according to claim 1, wherein in the locked position the first and second locking members engage each other in an interference fit.

4. The connection arrangement according to claim 1 wherein the first connecting portion comprises a first connection member and the second connecting portion includes a second connection member, and, wherein the first and second connection members are pivotally connectable so that when the first and second connection members are connected together the first and second locking members pivot relative to each other in an arc between separated and locking positions.

5. The connection arrangement according to claim 1 wherein the first connecting portion comprises a first connection member and the second connecting portion includes a second connection member, and wherein the first and second connection members comprise a slot and a ridge that is receivable within the slot to thereby connect the first and second connection members together.

6. The connection arrangement according to claim 1 wherein the first connecting portion comprises a first connection member and the second connecting portion includes a second connection member, and wherein the first connecting portion and the second connecting portion are of complementary shape and engage to form a pivot.

7. The connection arrangement according to claim 6 wherein the pivot is a hinge having a longitudinal axis substantially parallel to a direction of force applied to the device during use.

8. The connection arrangement according to claim 1, wherein the first connecting portion includes a first electrical contact and the second connecting portion includes a second electrical contact, the first and second electrical contacts being configured to come into physical contact when the first connecting portion mates with the second connecting portion.

9. The connection arrangement according to claim 1 wherein the power control module comprises a rechargeable power storage device

10. The connection arrangement according to claim 1, wherein the electrical device comprises a power tool module.

11. A connection for releasably connecting two parts of an electro-mechanical device, the connection comprising;
(i) a first connecting portion associated with a first part, and a second connecting portion associated with a second part, such that engagement of the first and second connecting portions imparts bias between the two parts, and
(ii) a retention means suitable for maintaining the bias between the two parts.

12. The connection according to claim 11, wherein in the locked position the first and second connection portions are compressed together.

13. The connection according to claim 11, wherein in the locked position the first and second locking members engage each other in an interference fit.

14. The connection arrangement according to claim 11 wherein the first connecting portion comprises a first connection member and the second connecting portion includes a second connection member, and wherein the first connecting portion and the second connecting portion are of complementary shape and engage to form a pivot.

15. The connection arrangement according to claim 14 wherein the pivot is a hinge having a longitudinal axis substantially parallel to a direction of force applied to the device during use.

16. The connection arrangement according to claim 11, wherein the first connecting portion includes a first electrical contact and the second connecting portion includes a second electrical contact, the first and second electrical contacts being configured to come into physical contact when the first connecting portion mates with the second connecting portion.
